(19) United States
(12) Patent Application Publication
(10) Pub. No.: US 2011/0055552 A1
(43) Pub. Date: Mar. 3, 2011

(54) PRIVATE, ACCOUNTABLE, AND PERSONALIZED INFORMATION DELIVERY IN A NETWORKED SYSTEM

(75) Inventors: Paul Francis, Kaiserslautern (DE); Saikat Guha, Kaiserslautern (DE); Hamed Haddadi, Kaiserslautern (DE)

(73) Assignee: Max Planck Gesellschaft zur Foerderung der Wissenschaften, Muenchen (DE)

(21) Appl. No.: 12/552,549

(22) Filed: Sep. 2, 2009

(51) Int. Cl. H04L 9/00; G06F 7/58

(52) U.S. Cl. 713/153; 708/250

(57) ABSTRACT

A client receives a notification of a user interaction with an information item and creates a record describing this interaction. The client encrypts the record using an encryption key associated with a server. The encrypted record is then communicated to at least one proxy, which in turn forwards the encrypted record to a server. Upon receiving the encrypted record from the proxy, a server decrypts the record using a decryption key and analyzes the decrypted record to identify the information item and the type of user interaction. This information may be used individually or in aggregate for tracking user interests, billing advertisers or information item providers, and/or collecting anonymous information from users.

### FIELD OF THE INVENTION

This invention relates generally to the field of information delivery on computer networks, and more particularly to systems and methods for efficiently providing individually targeted advertisements to users while protecting the users' privacy.

### BACKGROUND OF THE INVENTION

A major goal of advertising systems, Internet advertising included, is to accurately target the ad to the user. Unlike broadcast media like television and radio, which targets ads to groups of users, Internet ads can be targeted to individual users. This is good for the advertiser because less money is wasted presenting ads to users who don't care about them, and it is good for users because they are not bothered by ads that don't interest them.

However, individualized user targeting can also lead to loss of privacy. First, in order to be able to deliver personalized information such as ads, information about users must be gathered and stored. Second, information about which ads a user has seen and interacted with (for example clicked on), as well as which websites the ad was embedded in, must be gathered. This is necessary so that the advertiser can pay for having the ad delivered, and so that the website can be paid for providing the opportunity to show the ad. This is also necessary so that the advertiser can gauge the effectiveness of an ad, for instance, whether it is being clicked on or ignored. Revealing which websites a user has visited is a loss of privacy. Revealing which ads a user has been shown is also a loss of privacy, because the demographics and interests of a user can be deduced from the ads that are targeted to a user.

Prior systems allow advertisers to directly monitor specific users' Internet activity from somewhere in the network. For instance, prior ad delivery systems may be notified when an identified user visits websites that are either owned by the system or contain advertisements provided by the system, thus allowing it to generate a specific profile of this user. In another example, social networking web-sites gather information provided explicitly by their users.

Another prior system provides Internet Service Providers (ISPs) with software that allows them to monitor their users' browsing activity and send that information to an ad delivery system that generates a user profile which is then used to target ads to the users.

All of these prior systems have all been criticized for violating user privacy. In addition, these prior systems require substantial processing and storage resources and are therefore expensive to operate.

Another prior system gathers user information using a software agent executed on the user's computer to locally monitor the user's activity and/or data stored on the client computer and to select ads to be displayed to the user. In some prior systems, a user profile is transmitted to the ad delivery system, thus violating privacy. In other prior systems, the agent keeps the profile locally private, but requests ads from the ad delivery system. Even in this case user privacy is weakened, because the ad delivery system can see which ads the user agent requests, and can therefore deduce certain private information about the user. In still other prior systems, multiple ads are transmitted to the agent in advance. The agent then privately selects which to show. However, in these prior systems, the agent reports back to the ad delivery system which ads were shown, and on which websites they appeared, so that the system may bill the advertisers and pay web site operators accordingly. Thus, user privacy is also weakened for the same reason. In other prior systems, the agent does not report back to the ad delivery system. These systems are private, but they cannot be used in an advertising business in practice because they don't provide the information needed to run an advertising business: to bill advertisers and pay website operators, or to allow advertisers to manage their advertising campaigns.

There is an unmet need to provide methods and systems for delivering individually targeted information that is truly private, that targets users well, that provides the information needed to operate an advertising business, and that is not expensive to operate.

### SUMMARY OF THE INVENTION

According to an embodiment of the invention, a client receives a notification of a user interaction with an information item and creates a record describing this interaction. The client encrypts the record using an encryption key associated with a server. The encrypted record is then communicated to at least one proxy, which in turn forwards the encrypted record to a server. Upon receiving the encrypted record from the proxy, an embodiment of a server decrypts the record using a decryption key. The server then analyzes the decrypted record to identify the information item and the type of user interaction. This information may be used individually or in aggregate for tracking user interests, billing advertisers or information item providers, and/or collecting anonymous information from users.

In this embodiment of the invention, neither the proxy nor the server may obtain enough information to violate the user's privacy. The encrypted record does not include any information identifying a specific user; thus, the server receives no information that can identify the client. The proxy knows the client's network address, but cannot decrypt the records, so the proxy learns nothing about the client other than the fact that some interaction has taken place. As long as the operators of the server and proxy do not collude, neither can learn which interactions have taken place.

According to embodiments of the invention, an interaction may be of different types, e.g. the display of an information item, the click on an information item, a mouse over event, the filling in of a questionnaire etc. Interactions may be detected and recorded by means known to the skilled person, e.g. a mouse event listener, a Javascript module, etc. An information item may be an image, a video, text, audio or some combination. The information item may be a document or an advertisement. The information item is user specific in the sense that it is tailored to the user's interests, as determined for instance by a locally stored user profile, and may therefore reveal a user's private characteristics to any entity that knows which information items the user has interacted with. The information item may be associated with a category that may be matched with user-preferred categories stored in the user profile. The identifier associated with the information item may be a string or a number. It may uniquely identify the information item, the publisher of the information item or both. The publisher may be an advertiser, e.g. a company advertising its products or services. A record may be a data structure that may be transmitted over the network and interpreted by other computers. The client must not be known to the server, only the proxy. Concealing the identity may comprise removing the network address from a record received from the client computer.

### BRIEF DESCRIPTION OF THE DRAWINGS

The above and further aspects and advantages of the present invention may better be understood by referring to the following description taken in conjunction with the accompanying drawings, in which:

FIG. 1 is a diagram of a system according to a first embodiment of the invention;

FIG. 2 illustrates a method for providing anonymous indications of user interactions with information items according to an embodiment of the invention;

FIG. 3 illustrates example contents of an event record from an anonymous client according to an embodiment of the invention;

FIG. 4 illustrates a method of distributing information items to clients and tracking user interactions with these information items according to an embodiment of the invention;

FIG. 5 illustrates a method for anonymously obtaining information items according to an embodiment of the invention;

FIG. 6 illustrates a method of distributing information items to a multitude of clients according to an embodiment of the invention;

FIGS. 7A-7B illustrate example contents of an information item request and an information item reply according to an embodiment of the invention; and

FIG. 8 illustrates an example computer system suitable for implementing embodiments of the invention.

### DETAILED DESCRIPTION

The methods and systems for tracking user interactions with information items may be implemented on general purpose computers, connected by one or more local-area or wide-area networks, such as the Internet. More particularly, the general purpose computers may comprise a multitude of client computers, each client computer having one or more users, one or more proxy computers, wherein each client computer may access or address at least one proxy computer via the network and one or more server computers, each server computer accessible or addressable by at least one proxy computer. Moreover, the general purpose computers may further comprise information item provider computers.

Embodiments of the invention can include client computers in the form of desktop or portable personal computers; mobile communication devices, including mobile telephones; network connected devices adapted to connect with televisions, including set-top boxes and game consoles; and any other electronic devices capable of communicating via wired and/or wireless network interfaces with electronic communications networks, including local-area networks and wide area networks, such as the Internet, cellular data networks, cable television data networks, and one-way or two-way satellite data networks.

Embodiments of the invention may be used to track user interactions with information items. Information items include text, images, video, animation, speech, audio, three-dimensional computer graphics data and images or animation rendered there from, hypertext, graphical user interface widgets or controls, interactive content such as games, and computer-executed logic in the form of programs or scripts. Information items may be used for advertisements or for other purposes, such as providing information to users or soliciting user feedback. Examples of information items can include pop-up and banner advertisements, as well as advertisements appearing within the display or user interface of an application.

User interactions can include presenting an information item to a user, such that the information item is visible, audible, or otherwise perceivable to the user; receiving input from the user in response to an information item, such as mouse interactions, keyboard inputs, touchpad or touchscreen inputs, joystick or game controller inputs, and voice commands; and purchasing goods or services electronically via the information item. User interactions can include receiving user inputs with respect to specific portions of the information item, such as a user selecting a graphical user interface button within an information item.

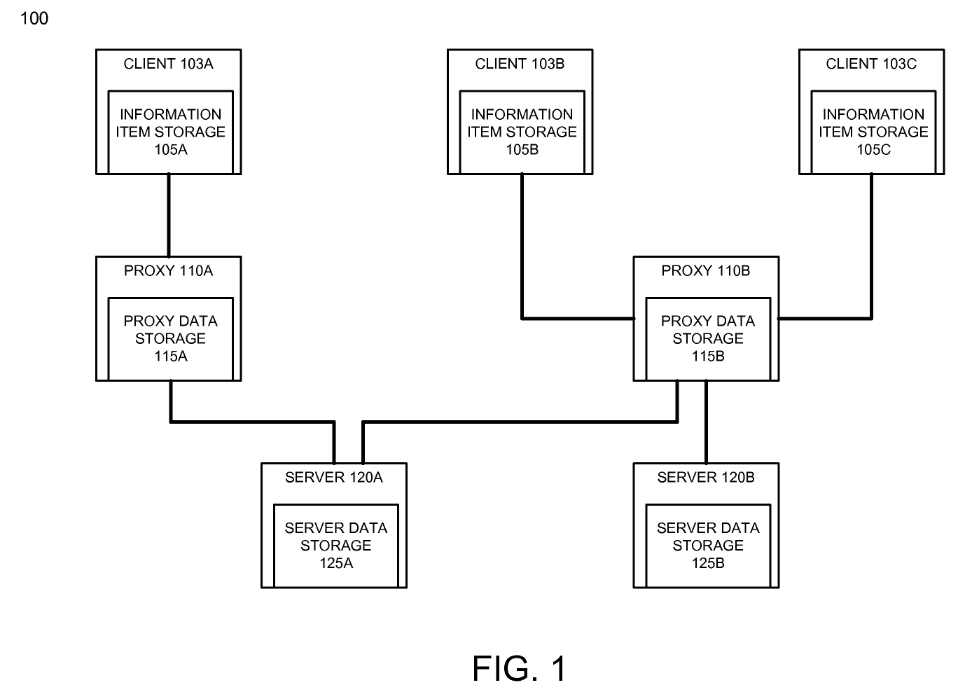

FIG. 1 is a diagram of a system 100 according to a first embodiment of the invention. The embodiment of the system 100 comprises clients 103, including clients 103a, 103b, and 103c. The clients 103 each include information items storage 105, including information items storage 105a, 105b, and 105c. Each of the information item storage 105 is adapted to store information items, associated information item identifiers, and one or more public keys from public-private server key pairs of one or several servers 120. In an embodiment, information items storage 105 is implemented as a database or other data structure, such as an array.

An embodiment of system 100 includes one or more proxies 110. In an embodiment, proxies 110 are distinct from both the clients 103 and servers 120. Clients 103 and servers 120 are adapted to communicate with proxies via one or more networks. Each of the proxies 110 is adapted to forward network traffic from one or more clients 103 to one or more servers 120. Additionally, each of the proxies 110 is adapted to forward network traffic from one or more servers 120 to one or more clients 103. In an embodiment, each of the proxies 110 includes a database or other data structure 115, such as an array, for matching clients 103 and servers 120 and is associated with at least one server 120. If the transport protocol used to carry messages transmitted between clients and servers via proxies is HTTP, then the proxies can be standard HTTP proxies. Clients can discover proxies through various commonly known means. For instance, the client can be pre-configured with the IP addresses of multiple proxies. Alternatively the client can be pre-configured with the Domain Name System (DNS) name of the proxies, and use DNS to discover the IP addresses of the proxies. Alternatively, the client could discover the server, and learn the IP addresses of proxies from the server.

Embodiments of system 100 may use a variety of network topologies to connect clients 103, proxies 110, and servers 120. For example, client 103a may be associated with proxy 110a, which in turn is associated with a single server 120a. In another example, multiple clients 103, such as clients 103b and 103c, may be associated with a single proxy 110b, which in turn is associated with multiple servers 120, including servers 120a and 120b. In another embodiment, a client may be associated with multiple proxies.

As discussed above, an embodiment of system 100 includes one or more servers 120. In system 100, each of the servers 120 is adapted to track client interactions with information items. In additional embodiments, servers 120 may also be adapted to distribute information items to clients 103. In further embodiments, servers 120 are adapted to communicate with advertiser systems to provide individual and aggregate client interaction data and for billing for advertisements. Embodiments of servers 120 each include a database or other data structure 125 for tracking user interactions with information items and to store at least the private keys from at least one public-private server key pairs. These private keys correspond with the public keys known to the clients 103.

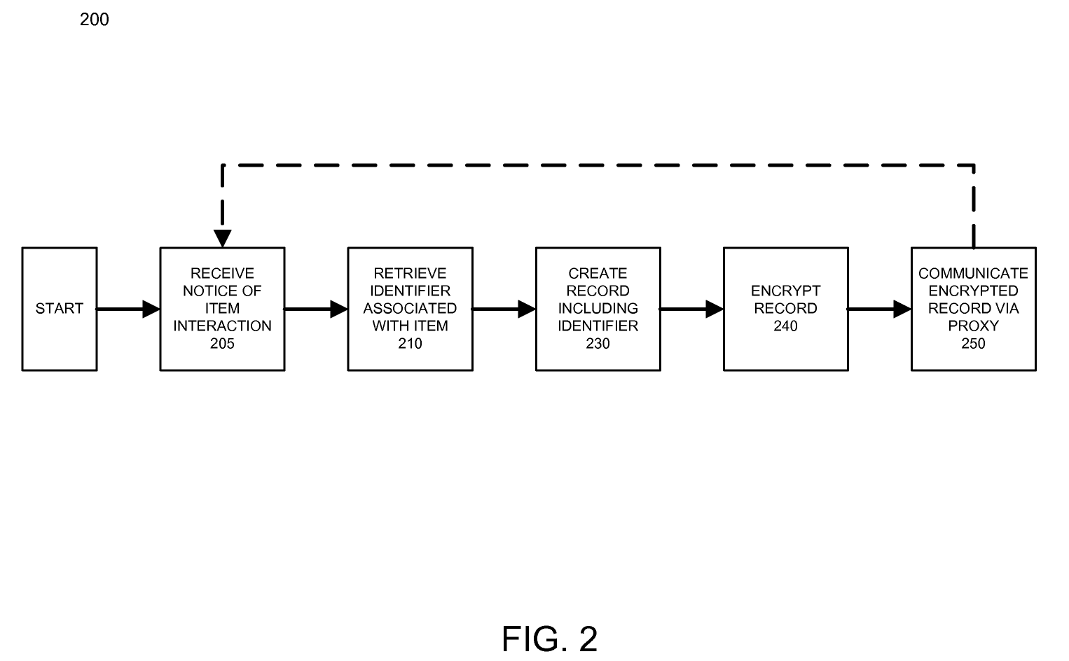

FIG. 2 illustrates a method 200 for providing anonymous indications of user interactions with information items according to an embodiment of the invention. Step 205 receives a notice of an item interaction. The notice of item interaction may be generated by a client application, such as a web browser or game application, in response to a user interaction with one or more information items. Embodiments of step 205 may receive this notice via an application programming interface, event notification system, or any other type of inter- or intra-application communication technique.

Step 210 retrieves an identifier associated with the information item. In an embodiment, each information item is associated with a unique identifier. In an embodiment, step 210 retrieves the identifier associated with the information item from a database or other data structure accessible to the client, such as one of the information item storage 105 illustrated in FIG. 1.

Step 230 creates a record of the information item interaction for communication with a server.

Step 240 encrypts the record using the public encryption key of the server computer. Embodiments of the invention may use any type of public-key cryptography technique known in the art, including Diffie-Hellman, DSS, and Elliptic Curve asymmetric key techniques. The client may learn the public key or keys through any number of well-known means. For instance, it may be pre-configured into the client software. Alternatively, it could be obtained through a Public Key Infrastructure (PKI).

Step 250 transmits the encrypted record to a proxy via one or more networks. The proxy is adapted to receive the encrypted record and forward it to an appropriate server. Because the server receives the encrypted record from the proxy, rather than directly from the client, the identity of the client is unknown to the server. Additionally, because the record is encrypted using a public key associated with the server, the proxy cannot read the contents of the encrypted record. Thus, although the proxy knows the identity of the client, it does not know anything about the client's user interactions. The proxy can select the appropriate server using any number of commonly known means. For instance, the proxy can be pre-configured with the IP addresses of multiple servers. Alternatively the proxy can be pre-configured with the Domain Name System (DNS) name of the servers, and use DNS to discover the IP addresses of the proxies.

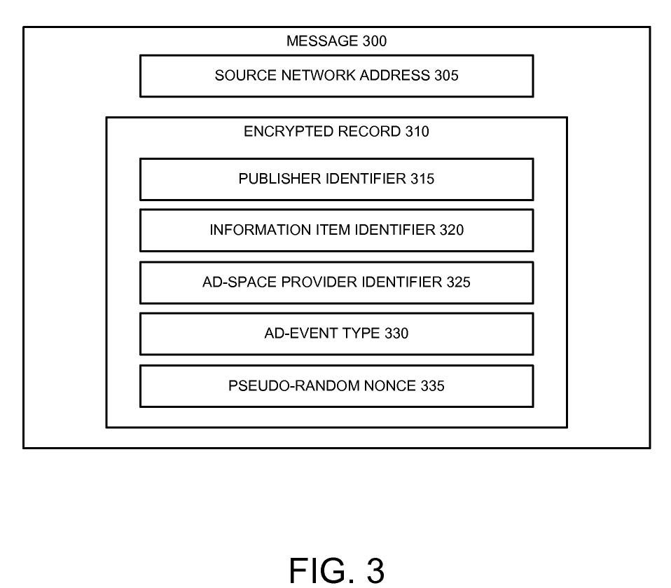

FIG. 3 illustrates example contents of an event record from an anonymous client according to an embodiment of the invention. A message 300 includes an unencrypted portion adapted to directed the message to a proxy and ultimately to a server. In an embodiment, this unencrypted portion of message 300 also includes a source network address 305, corresponding with the network address of the client sending the message. The message may contain other unencrypted fields commonly required to transmit messages over the Internet, such as IP, TCP, UDP, HTTP, XML, or other types of headers.

Message 300 also includes an encrypted record 310. The encrypted record includes one or more data fields associated with the user interaction with an information item. These data fields allow for billing publishers or other information item providers based on the type of information item, the type of interaction, the location or type of presentation of the information, and other factors. These data fields also allow publishers or other information item providers to track the usage of their information items.

An example of encrypted record 310 may include a Publisher Identifier 315 associated with the information item. The Publisher Identifier 315 identifies the publisher or information item provider.

A publisher may be publishing multiple different information items at the same time, and may be paying different amounts for different information items. Thus, an example of encrypted record 310 may also include an Information Item Identifier 320 that uniquely identifies an information item at least among all of a publisher's information items, if not among all of the information items. In an alternate embodiment, both the publisher identifier 315 and information item identifier 320 may be identified using a single combined identifier.

A publisher may pay different amounts for different types of ad events, such as views, clicks, purchases. A publisher may also want to know the type of ad event in order to help manage its ad campaign. For instance, the advertiser may know how well an ad is working based on the number of clicks per view. To support this, the encrypted record 310 may include an Ad-event Type 330. The Ad-event Type 330 specifies the type of user interaction with the information item, such as a mouse click, keyboard input, a viewing or presentation to the user, or a user purchase via an interaction with an information item.

For a user to interact with an information item, that information item has to be presented to the user. One way of doing this is within web pages, where ad space has been made available on the web page for placing ads. Another way is to provide space in the Graphical User Interface (GUI) of an application. Still another way is to place the ad within a game, for instance through product placement or a billboard. In all of these cases, there is an ad-space provider: a web site, application developer, or game developer who provides the opportunity for a user to interact with an information item. The ad-space provider may be paid for providing the opportunity. To support this, an embodiment of an encrypted record includes Ad-space Provider Identifier 325. The Ad-space Provider Identifier 325 identifies the provider that presents the information item to the user and allows the server to store and tabulate the information needed to pay the ad-space provider. The record may additionally contain other information, such as information about the bid amount associated with the information item.

In a further embodiment, the security of the encrypted record 310 is enhanced by including a nonce 335, or number used once. The nonce is a large random or pseudo-random number that is added to the record prior to encryption to make dictionary attacks on the encrypted record 310 impractical.

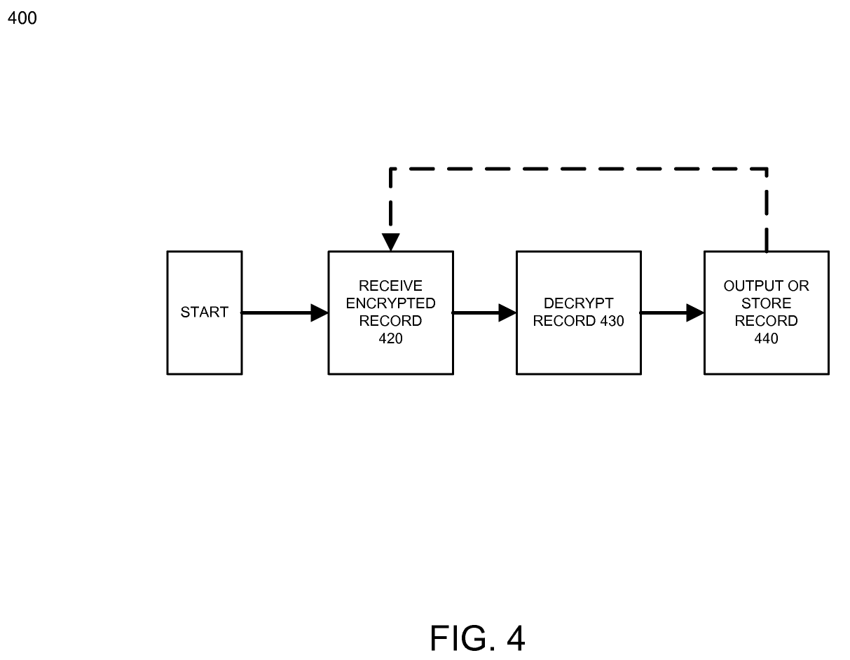

FIG. 4 illustrates a method 400 tracking user interactions with information items according to an embodiment of the invention. Step 420 of method 400 receives a message from a proxy. The message from the proxy includes an encrypted record from a client. Because the message is communicated via a proxy, the source network address of the received message is that of the proxy, rather than that of the client that created the encrypted record. Because of this, the server does not know the identity of the client that generated the encrypted record. Thus,

Step 430 decrypts the encrypted record. In an embodiment, the encrypted record is encrypted using a public key of a public-private server key pair. Step 430 uses the private key of the public-private server key pair to decrypt the encrypted record. The decryption step 430 may be done by the server itself, or it may be offloaded to another system. For example, the decryption could be done by a dedicated system using specialized decryption hardware. Alternatively, the decryption could be done by other clients. In this case, clients could generate public-private key pairs and convey the public keys to other clients. The other clients would use the public key to encrypt the message, and transmit the encrypted message to the server via the proxy, which would forward the encrypted message to the client that generated the key pair. This client would decrypt the message, and send the decrypted message back to the server.

Step 440 outputs or stores one or more records based on the received message and the decrypted contents of the encrypted records. In an embodiment, step 440 stores a record including one or more of the identifiers included in the encrypted record, such as a publisher identifier, an information item identifier, an ad-space provider identifier, and/or an ad-event type identifier. Optionally, an embodiment of step 440 may output a record based on one or more of the identifiers to a publisher, ad-space provider, or other third-party for the purposes of billing, monitoring user activity, or tracking the effectiveness of information items or ad-space. Records may be output for each ad event or received message, or an aggregate record may be output for a group of ad events.

In an embodiment, multiple information items are distributed to clients in advance of their presentation to users. Clients determine which of these information items should be presented to users at any given time. In practice, it may be too expensive to distribute every information item to every client, as this may take up too much bandwidth and storage in the client. Thus, an embodiment of the invention distributes only the information items likely to be of interest to the user to the client, without revealing client identity.

In an embodiment, servers distribute information items to clients. These information items may be distributed to clients through any number of well-understood mechanisms. For instance, they can be transmitted directly to clients from the server, without going through a proxy. Alternatively, they could be distributed through a content distribution network such as Akamai. They could also be distributed via a peer-to-peer technology like BitTorrent or others, or any combination of the previous mechanisms. In all of these cases, it is generally possible to know which clients received which information items. It is therefore important in these cases to give the same information item to enough clients that the identity of a client cannot be deduced when a client later reports an interaction with an information item.

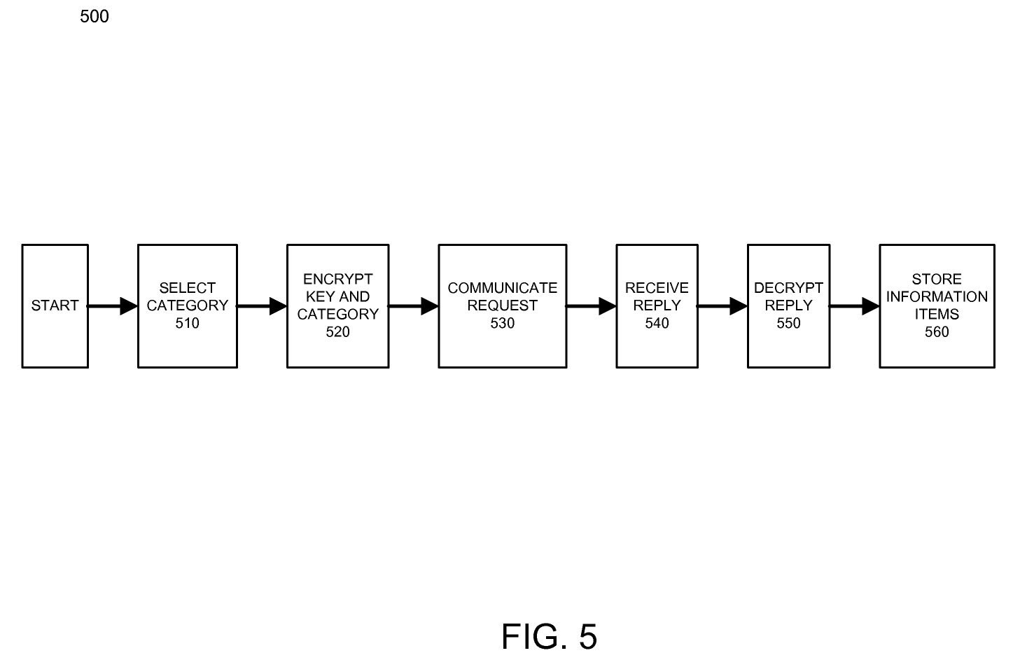

FIG. 5 illustrates a method 500 for anonymously obtaining information items according to an embodiment of the invention. Step 510 selects one or more information item categories. An information item category may be associated with user interests, user demographics, or combinations of user interests and demographics. The client may associate a user with certain categories through the user profile generated by the client. The user profile may be generated by a number of commonly known means. It may monitor the user's on-line activity, for instance, the web-sites the user visits, the products the user shops for, emails the user sends and receives, the chat-rooms the user visits, and so on. It may additionally scan user data, for instance emails stored on the user's computer, the documents and articles stored on the user's computer, songs and movies stored on the computer, the profiles the user has input into social networking sites, and so on. It may monitor the types of applications the user uses, such as games, financial software, and so on. It may use user activity to infer the mood of the user, for instance the rate at which the user types, the contents of the user's input, or the music or movies the user is watching and listening to.

Step 520 creates a request message including a category and a client encryption key. In an embodiment, the client encryption key is a symmetric key capable of encrypting and decrypting data. In alternate embodiments, the client encryption key is a public key of a public-private client key pair. In a further embodiment, step 520 creates multiple request messages to indicate a user's interest in multiple categories, with each category included in a separate request message. In still a further embodiment, each of the multiple request messages includes a different client encryption key.

Following the creation of the request message, step 520 encrypts at least the category and the client encryption key using a server public key.

Step 530 communicates the encrypted request to the server via at least one proxy. The encrypted request message includes the client's network address as a source network address. This source network address will be omitted as the encrypted request is forwarded from the proxy to the server, thereby making the client anonymous to the server.

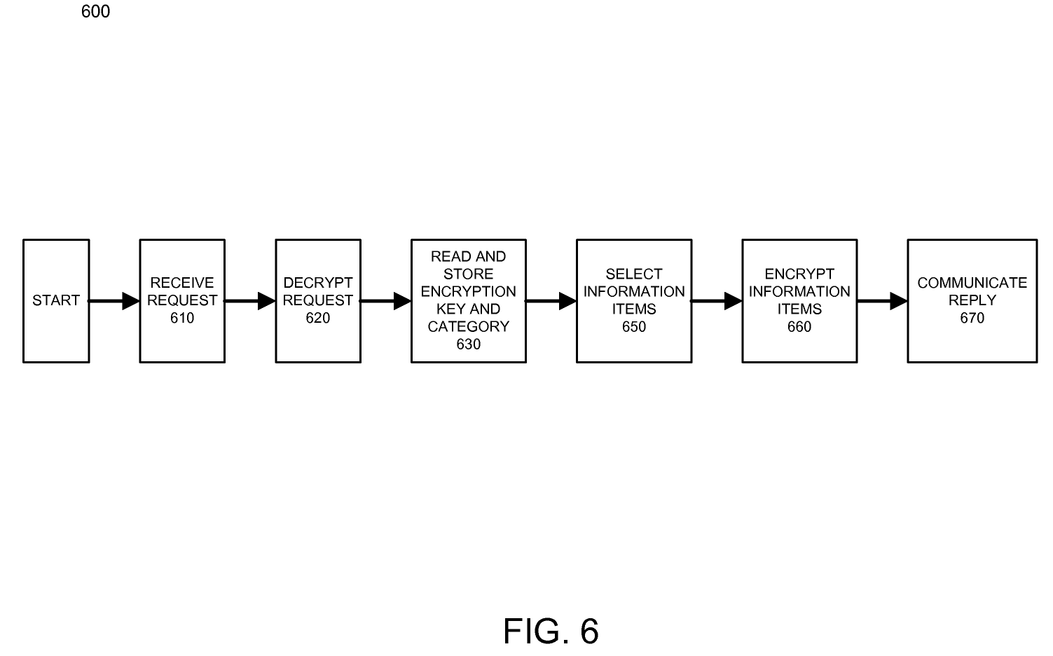

In an embodiment, the server receives and processes the encrypted request message from the client and sends one or more encrypted reply messages to the client via at least one proxy. This is discussed in detail below in reference to FIG. 6. Step 540 receives an encrypted reply from the server via a proxy. The encrypted reply includes one or more information items associated with at least one category included in the request message.

Step 550 decrypts the encrypted reply with a client decryption key. In an embodiment, the client decryption key may be the same as the client encryption key included in the request message. In another embodiment, the client decryption key may be a private key of a public-private client key pair. Step 560 stores the information items in the decrypted reply in a data structure or memory for subsequent presentation to the user.

FIG. 6 illustrates a method 600 of distributing information items to a multitude of clients according to an embodiment of the invention. Step 610 receives an encrypted request for information items from a client via a proxy. In an embodiment, the request is encrypted by the client using a public key of a public-private server key pair.

Step 620 decrypts the encrypted request using the private key associated with the public key used to encrypt the request. In an embodiment, step 620 uses the private key of the public-private server key pair to decrypt the encrypted request.

Step 630 accesses a client encryption key and category from the decrypted request and stores the client encryption key and category in a computer-readable memory for later use.

Step 650 selects one or more information items associated with the category. In an embodiment, a publisher or information item provider associates each of their information items with one or more categories.

Step 660 creates a reply message including the selected information items. In an embodiment, step 660 encrypts the reply message with the client encryption key provided with the request message to form an encrypted reply. An embodiment of step 660 may create multiple replies with different information items in each reply. An embodiment of step 660 may also create additional replies at a later point in time if additional information items are subsequently received from publishers or information item providers and/or are associated with the category provided by the client in the request.

Step 670 transmits the encrypted reply to the proxy. The proxy in turn transmits the encrypted reply to the client directly or via one or more additional proxies. To know which client to send the reply to, the proxy must have some way of associating the original request with the subsequent replies. This may be done by maintaining Transmission Control Protocol (TCP) connections with the server and client, and associating the two TCP connections with each other. This may also be done by creating a unique request identifier and associating that identifier with the client. The server may then return the request identifier with the replies, allowing the proxy to associate the replies with the client.

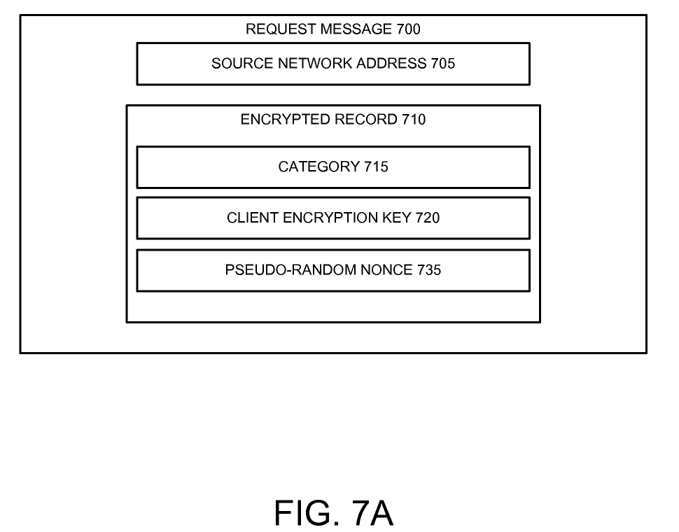

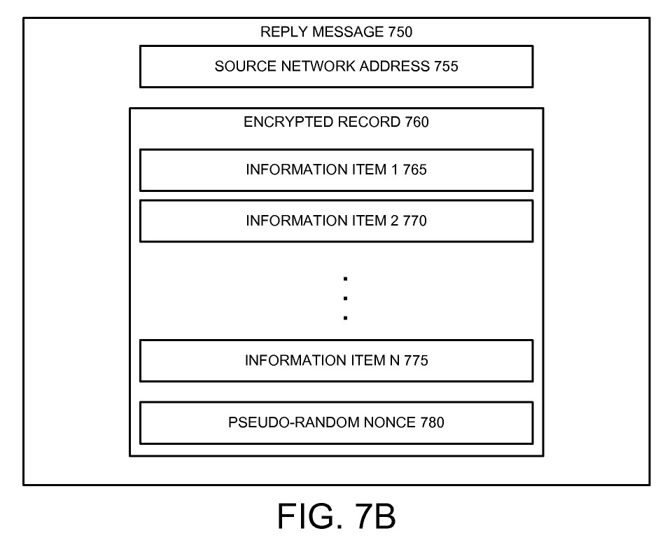

FIGS. 7A-7B illustrate example contents of an information item request and an information item reply according to an embodiment of the invention.

FIG. 7A illustrates an example request message. Example request message 700 includes an unencrypted portion adapted to directed the message to a proxy and ultimately to a server. In an embodiment, this unencrypted portion of request message 700 also includes a source network address 705, corresponding with the network address of the client sending the message. As this request message 700 is forward by a proxy to either another proxy or the server, this source network address 705 is replaced with the network address of the sending proxy.

Request message 700 also includes an encrypted record 710. The encrypted record is encrypted at least once with a server public key. The encrypted record 710 includes one or more data fields used to request information items from the server. An examples of these data fields includes one or more categories 715 identifying the type of information items suitable for presentation to users by the client. In an alternate embodiment, each request message 700 only includes a single category, so as to prevent servers or other third-parties from identifying clients from the combinations of categories requested.

Another example of these data fields include a client encryption key 720. The client encryption key may be a symmetric key or a public key of a public-private client key pair. In a further embodiment, the client encryption key 720 may be unique for each category requested by the client, so as to prevent servers or other third parties from identifying clients by their client encryption key 720.

In an embodiment, the encrypted record 710 also includes a nonce 735 to prevent dictionary attacks.

FIG. 7B illustrates an example reply message 750. Example reply message includes an unencrypted portion adapted to direct the message to a proxy and ultimately to the client.

Reply message 750 also includes an encrypted record 760. The encrypted record 760 is encrypted with the client encryption key 720 provided in the request message 700. The encrypted record 760 includes one or more information items, such as information items 765, 770, and 775. In an embodiment, the encrypted record 760 also includes a nonce 780 to prevent dictionary attacks.

Because the user has no reason to trust the client software, it is important that users have a way to validate that no private or personally identifying information is being revealed in the encrypted portion of the transmissions leaving the client. The information in the messages 310, 710, and 760 do not reveal private information. Assuming that categories are reasonably broad, any of thousands of clients may select or view any given category or ad. Given this, a user need only validate that the contents of messages are limited to what is supposed to be in them to be sure that private information is not being leaked.

In an embodiment, for each encrypted record 310 and 710 transmitted by the client, the client makes available to the user the unencrypted message contents. The user obtains the server public key, either by getting it directly from the client, or through some public means such as publication on a web-site or via a PKI. The user (or trusted software operating on behalf of the user) can encrypt the message contents using the server public key and produce an encrypted message. If this encrypted message is the same as the encrypted message transmitted by the client, then the user can be confident that only the message contents is carried in the encrypted record. Alternatively, trusted software operating on behalf of the user can carry out the encryption itself. In this case, the client provides the unencrypted message contents to the trusted software, which can itself check that the contents do not reveal private information, and then encrypt the contents and give the encrypted record back to the client, which then transmits it to the server via the proxy.

It is important that the proxy cannot learn the contents of the encrypted messages. If it can, then it can learn private information about individual users: which websites the user has visited, which ads the user interacts with, and which categories the user has requested.

For example, if a malicious or compromised proxy can guess the contents of the encrypted message (record, request, or reply), then it can encrypt its guess with the server public key and match the resulting encrypted record against that in the record. If they match, then the proxy knows the contents of the encrypted message. If there is a limited amount of predictable information in the message, then the proxy can reasonably attempt every possible message contents until it guesses the right one. This is known as a dictionary attack.

Embodiments of the invention prevent dictionary attack by including a nonce or number-used-once in their encrypted messages. A nonce is a large random or seemingly random number that is extremely costly to guess, making the dictionary attack impractical.

However, because the nonce is a large random-looking number, it is possible for a malicious or compromised client to use the nonce as a covert channel for communicating private user information with a server or other third-party. For example, a malicious or compromised client may hide the network address of the client in the nonce. To give the user confidence that the nonce is not a covert channel, the nonce may be produced by a pseudo-random number generator. The user may either be given the seed to the pseudo-random number generator, or allowed to generate one his or herself. Either way, the sequence of nonces is subsequently deterministic, and therefore cannot convey any covert information. The user can validate that the sequence of nonces is correct by running the same pseudo-random number generator in parallel and checking that the numbers match those produced by the client.

If the server and the proxy collude, then they can reveal private user information. For instance, the proxy could transmit client network addresses to the server along with records and replies. One way to detect this collusion is for an independent agency to monitor all communications in and out of the proxy. Alternatively, the server and proxy could both maintain a log of records. By comparing logs, the server can learn the network address associated with each record. One way to detect this collusion is to have an independent agency audit the internal operation of the proxy, to insure that no logs are being stored.

If these measures are not considered adequate, a further embodiment of the invention may include a second proxy to make collusion between the first proxy and the server ineffective. In this embodiment, messages travel from the client to the first proxy, then to the second proxy, and then to the server.

In this embodiment, a client may encrypt a record twice, first with a server public key and then with a public key of the second proxy. This double-encrypted record is transmitted to the first proxy, which forwards it to the second proxy, thus hiding the identity of the client from the second proxy. The second proxy then decrypts the record using its private key, and passes the now single-encrypted record to the server, where it can be decrypted with the server private key. In this embodiment, collusion between any two components cannot reveal private information. Collusion between the two proxies is not useful because neither can see the contents of the messages. Collusion between the server and the second proxy is not useful because the second proxy does not know the network addresses of the clients. Finally, collusion between the server and the first proxy is not useful because the server cannot associate the messages that it receives with the messages that first proxy sent, since they are different. If necessary, the second proxy can also delay transmission of its messages to remove any time correlation between its transmissions and the first proxy's transmissions.

In a further embodiment of the invention, a content server may further be involved in the process of distributing information items and tracking the interactions of users with such items.

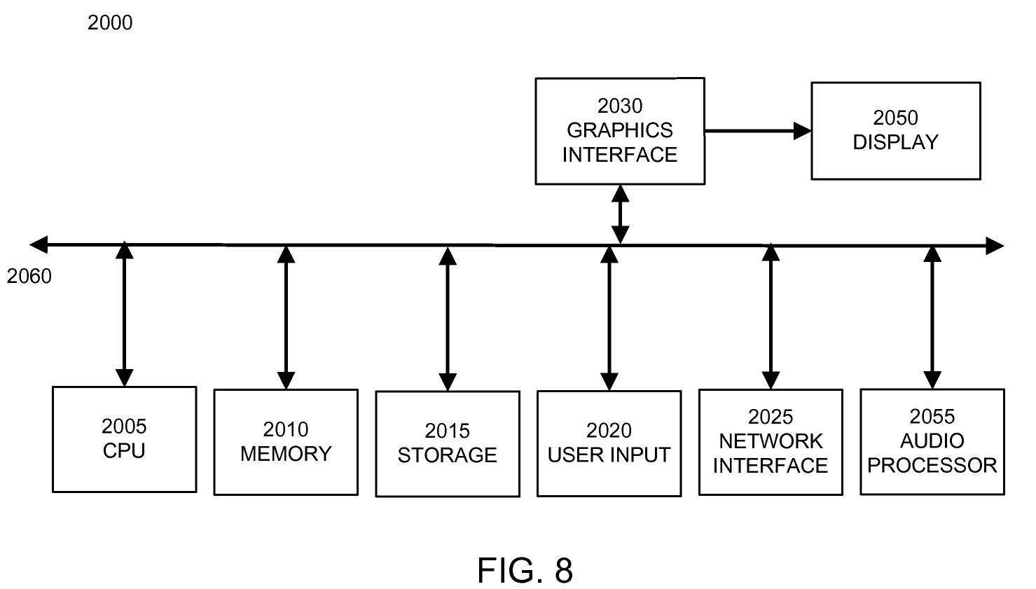

FIG. 8 illustrates an example computer system 2000 suitable for implementing embodiments of the invention. FIG. 8 is a block diagram of a computer system 2000, such as a personal computer, server computer, video game console, personal digital assistant, or other digital device, suitable for practicing an embodiment of the invention. Computer system 2000 includes a central processing unit (CPU) 2005 for running software applications and optionally an operating system. CPU 2005 may be comprised of one or more processing cores. Memory 2010 stores applications and data for use by the CPU 2005. Storage 2015 provides non-volatile storage for applications and data and may include fixed or removable hard disk drives, flash memory devices, and CD-ROM, DVD-ROM, Blu-ray, HD-DVD, or other magnetic, optical, or solid state storage devices.

User input devices 2020 communicate user inputs from one or more users to the computer system 2000, examples of which may include keyboards, mice, joysticks, digitizer tablets, touch pads, single or multitouch touch screens, still or video cameras, and/or microphones. Network interface 2025 allows computer system 2000 to communicate with other computer systems via an electronic communications network, and may include wired or wireless communication over local area networks and wide area networks such as the Internet. An optional audio processor 2055 is adapted to generate analog or digital audio output from instructions and/or data provided by the CPU 2005, memory 2010, and/or storage 2015. The components of computer system 2000, including CPU 2005, memory 2010, data storage 2015, user input devices 2020, network interface 2025, and audio processor 2055 are connected via one or more data buses 2060.

A graphics interface 2030 is further connected with data bus 2060 and the components of the computer system 2000. The graphics interface 2030 is adapted to output pixel data for an image to be displayed on display device 2050. Display device 2050 is any device capable of displaying visual information in response to a signal from the computer system 2000, including CRT, LCD, plasma, OLED, and SED displays. Computer system 2000 can provide the display device 2050 with an analog or digital signal.

In embodiments of the invention, CPU 2005 is one or more general-purpose microprocessors having one or more homogenous or heterogeneous processing cores. Computer system 2000 may further implement one or more virtual machines for executing all or portions of embodiments of the invention.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method for indicating an interaction of a user with an information item to a server computer, the method comprising:
storing, in a memory of a client computer, information items and associated identifiers;
in response to a user interaction with a first one of the information items, creating a record of the interaction, wherein the record comprises the publisher identifier associated with the first information item;
encrypting the record using an encryption key of the server computer; and
transmitting the encrypted record to the server computer via a proxy computer adapted to conceal a network address of the client computer.

2. The method of claim 1, wherein the proxy computer is distinct from the client computer and the server computer.

3. The method according to claim 1, wherein the record includes the ad-event type.

4. The method according to claim 1, wherein the record includes the ad-space provider identifier for the interaction.

5. The method according to claim 1, wherein the record includes the information-item identifier for the interaction.

6. The method according to claim 1, wherein the record comprises a pseudo-randomly generated nonce.

7. The method according to claim 4, comprising:
providing the content of the record, the encryption key and a seed for the nonce to the user.

8. The method according to claim 1, wherein at least a portion of the information items stored in the memory is based on a user profile.

9. The method of claim 8, wherein the user profile is stored in the memory of the client computer.

10. The method according to claim 1, wherein the information items include an advertisement.

11. The method of claim 1, wherein at least a portion of the information items are adapted to be presented within a client application.

12. The method of claim 11, wherein the client application includes a web browser.

13. The method of claim 11, wherein the client application includes a video game.

14. The method according to claim 1, wherein storing, in the memory of the client computer, information items and associated identifiers comprises:
selecting at least one information item category;
encrypting a client encryption key and the information item category with the encryption key of the server computer to produce an encrypted request;
transmitting the encrypted request to the server computer via the proxy computer;
receiving an encrypted reply from the server computer via the proxy computer, wherein the encrypted reply comprises the information items;
decrypting the encrypted reply with the client decryption key to allow access to the information items; and
storing the information items included in the decrypted reply in the memory.

15. The method according to claim 1, wherein the client additionally double-encrypts the record using the public key of a second proxy, transmitting the record to the server via the first proxy followed by the second proxy.

16. A computer-readable medium comprising instructions adapted to direct a computer to execute a method according to claim 1.

17. A method for tracking interactions of users with information items on client computers, comprising the steps:
distributing information items and associated identifiers to clients;
receiving via a proxy computer an encrypted record from a client computer, wherein the encrypted record comprises a first one of the identifiers associated with a first one of the information items;
decrypting the record with a decryption key of the server computer; and
storing the record in a memory of a server computer.

18. The method of claim 17, wherein the proxy computer is distinct from the client computers and server computer.

19. The method according to claim 17, a first portion of the information items distributed to a first client computer and a second portion of the information items distributed to a second client computer each include a third identical portion.

20. The method according to claim 19, wherein the third portion is selected such that the probability of identifying the first client computer given the first one of the identifiers associated with the first one of the information items is negligible.

21. The method according to claim 17, comprising:
distributing the information items based on at least one category associated with the information items.

22. The method according to claim 17, further comprising the step of providing the information item identifier to the publisher.

23. The method according to claim 17, further comprising the steps of:
maintaining a count of information item identifiers received for an ad-space provider; and
signaling the count to the ad-space provider.

24. A method of distributing information items to an anonymous client, the method comprising:
receiving an encrypted request from a client computer via a proxy computer;
decrypting the encrypted request using the decryption key;
reading a client encryption key and the category from the decrypted request;
selecting at least one information item associated with the category;
encrypting the information item with the client encryption key to form an encrypted reply; and
transmitting the encrypted reply to the client computer via the proxy computer.
